(19) United States
(12) Patent Application Publication
(10) Pub. No.: US 2004/0043362 A1
(43) Pub. Date: Mar. 4, 2004

(54) Re-configurable e-learning activity and method of making

(76) Inventors: Robert S. Aughenbaugh, Portland, OR (US); Bruce A. Carocci, West Linn, OR (US)

Correspondence Address: ROBERT D. VARITZ, P.C., 2007 S.E. Grant Street, Portland, OR, 97201, US

(21) Appl. No.: 10/230,600

(22) Filed: Aug. 29, 2002

(51) Int. Cl. G09B 19/00

(52) U.S. Cl. 434/118

(57) ABSTRACT

A method, apparatus, and resulting product involving the building, use and specific make-up of an e-learning, e-training, activity. This activity includes a core component template of activity-specific attributes, to which are linked to independently selectable and useable specific training information elements which collectively form the other major component in a completed e-learning activity. The training personality and content of a created activity are freely revisable and re-configurable either through the technique of changing, in some manner, the specific information-training contents in the activity, and/or changing the core make-up of activity attributes in the template of attributes which forms part of the activity.

### BACKGROUND AND SUMMARY OF THE INVENTION

This invention relates to the structure, the making of, and the delivery and use of so-called electronic-learning, or e-learning, activities which are deliverable for use and are employable in the context of different forms of contemporary data-communication systems and environments. Such environments can include, without limit, that of a single hand-held type computer, a stand-alone workstation, laptop or desktop computer, a local-area-network(LAN)-connected computer, a wide-area-network(WAN)-connected computer and an Internet-connected computer. As suggested, these particularly stated environments are but representative of what is referred to herein by the phrase “data-communication environment”.

While the invention will clearly be seen to have utility in a number of fields of training and learning, a preferred embodiment, and a preferred manner of practicing and using the present invention are disclosed herein in conjunction with various forms of sales-training activities deemed to be widely useful in today's commercial world.

As those skilled in the art will immediately recognize, in the field of sales training, there are many different facets and areas which are considered to be very important. Each of these areas is well understood to be characterizable in a number of different ways to suit different specific purposes and situations. For example, in a sales training activity which is designed to offer training regarding completing a successful sales transaction by “making a deal”, the specific ways in which sales personnel can be trained in this field of activity are very wide spread and often are handled and dealt with by different vendors of goods and services with a very wide range of approaches. This being the case, it is very clear that, while there are certainly fundamental attributes that can be said to be associable with a “make the deal” type training activity under most all circumstances, accommodation for including various different specific components of training information is important in order to suit the wishes and tastes of different vendors.

Thus, it is important that, with regard to any training program that is developed, and which is hoped to have widespread utility, such a program ought to be made in such a fashion that it is highly and easily tailorable and re-configurable by specific users who may wish to offer their trainees different kinds of approaches and indeed different approaches which can change from time to time.

The present invention proposes (a) a novel e-learning activity structure, (b) a method of building and making that structure, and (c) a methodology enabling easy and very versatile re-configuring of that activity. According to a preferred embodiment of an activity constructed in accordance with this invention, that activity takes the form, in an electronic data format, of what is referred to herein as an activity template which essentially is a template made up of particular selected attributes chosen to lie as a core framework for the building of specific e-learning training approaches that are aimed at promoting that specific activity. In one manner of practicing the invention, such a template is itself is offered as a changeable core component—one which a user can reconstruct by re-configuring the makeup of core attributes. In what is considered to be the preferred form of the invention, core templates themselves are not necessarily modifiable. Rather, they are offered in such a manner that, while they may have nominally linked to them pre-selected default data-components that relate to specific information which is to be delivered and employed in the implementation of a sales training activity, a user is given the free opportunity to revise and re-configure the specific activity data components (information components) which are linked to the core attributes. With this re-configurability possibility made available, a user can freely and very flexibly make changes from time to time in the approach used for a particular sales training activity.

Handily enabling this important reconfigurability as offered by the present invention is the fact that the core template components are structured in such a way that they are effectively independent of linked specific activity information data. This de-linking and state of independence offers a rich opportunity for variation in the hands of a user who has obtained a useful core template made in accordance with the invention.

With respect to the fundamental makeup of an activity for e-learning built in accordance with the present invention, which activity includes a core template of attributes with respect to which specific activity data components can be linked, attribute elements within the template include, as non-exhaustive examples, the name of the activity to be trained for, the general attitude and approach which is to be employed in training, the style of training with respect to how content information is delivered to a trainee and how responses are solicited and evaluated from and with respect to a trainee, the overall core structure of content which a user feels needs to be delivered to a trainee in order to embrace a particular activity training, elements of styles such as color, the presentation of logos, the use of animation, the integration of visual and sound images with printed text and numbers, whether merit awards or statements of congratulations are to be delivered in some fashion, and so on. It is with respect to a template possessing such attribute characteristics that specific content information is linked, preferably in a very freely re-configurable and revisable form. Thus, with respect, for example, to the manner in which content is delivered to a trainee, this information content might include the exact texts of a handful of different statements, questions, propositions, relationships, etc. that are to be presented. It can include whether and how this content information is delivered for example visually in printed text, in moving animation, in color renderings, in sound tracks, etc. The manner of delivery of such information can be functionally guided by those attributes built into a template which, for example, endows the presentation to a trainee with what can be thought of as the personality of the training activity—a personality which has been consciously selected for use.

These and other important and obvious advantages and creative offerings made by the structure and methodology of the present invention will now become more fully apparent as the description which follows is read in conjunction with the accompanying drawings.

### DESCRIPTION OF THE DRAWINGS

FIG. 1 is a block/schematic diagram, in somewhat simplified but nonetheless highly informative form, illustrating the structure and making of an e-learning, e-training activity in accordance with practice of the present invention.

FIG. 2 is a simplified block/schematic diagram illustrating somewhat more specifically how a core template of e-learning activity attributes can be flexibly and re-configurably combined with selected specific activity information components to build, in a very changeable, and selectably modifyable way, the e-learning activity illustrated in FIG. 1.

FIG. 3 is a simplified block/schematic diagram illustrating how, in accordance with a modified form of and manner of practicing the invention, a core activity template which forms part of an activity in accordance with this invention can itself be selectively re-configured and re-styled as desired.

In these three drawing figures three different shading styles are employed, one of which utilizes angled shading lines which slope upwardly and to the right, another of which employs more densely packed shading lines that are angled and that slope upwardly and to the left, and a third quality of shading where criss-crossing shading lines are employed. The block structures, and fragments thereof, which contain these respective three different characters of shading are, from figure to figure, essentially the same components or elements. Thus, these shading lines are provided as an aid in relating what is shown in each of these three figures with what is shown in the other two drawing figures.

FIGS. 4a-4f, inclusive, illustrate, in words and images, practice of the invention to create an e-learning activity called “Good Question Game Activity”.

FIGS. 5a-5d are similar in character to FIGS. 4a-4f, except that here what is pictured is employment or practice of the invention to create another e-learning activity which is entitled “Drag and Drop”.

### DETAILED DESCRIPTION OF THE INVENTION

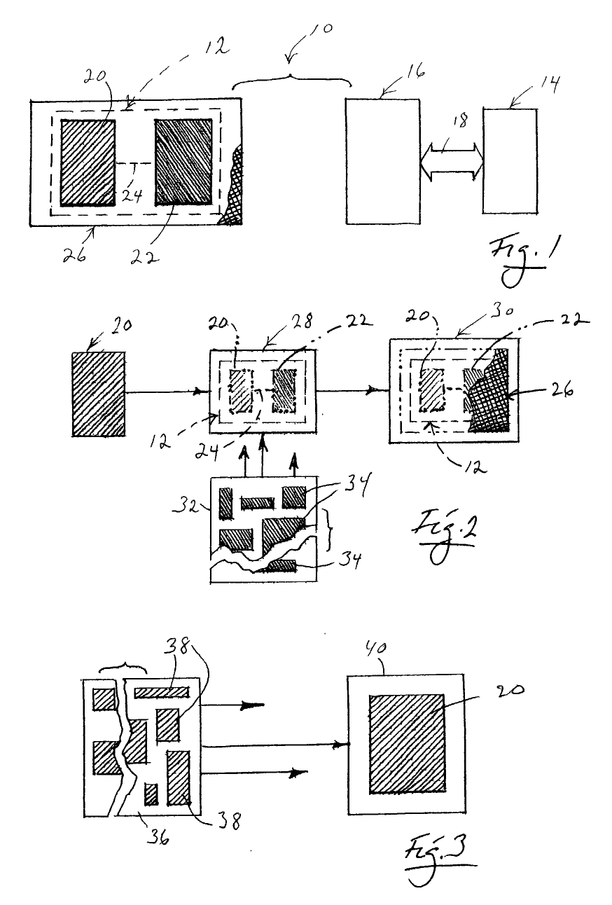

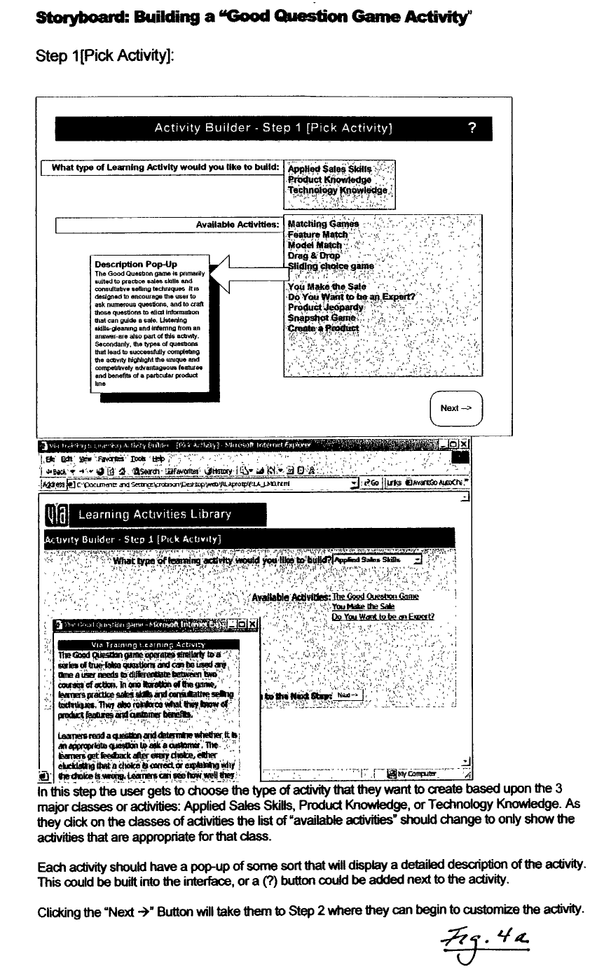

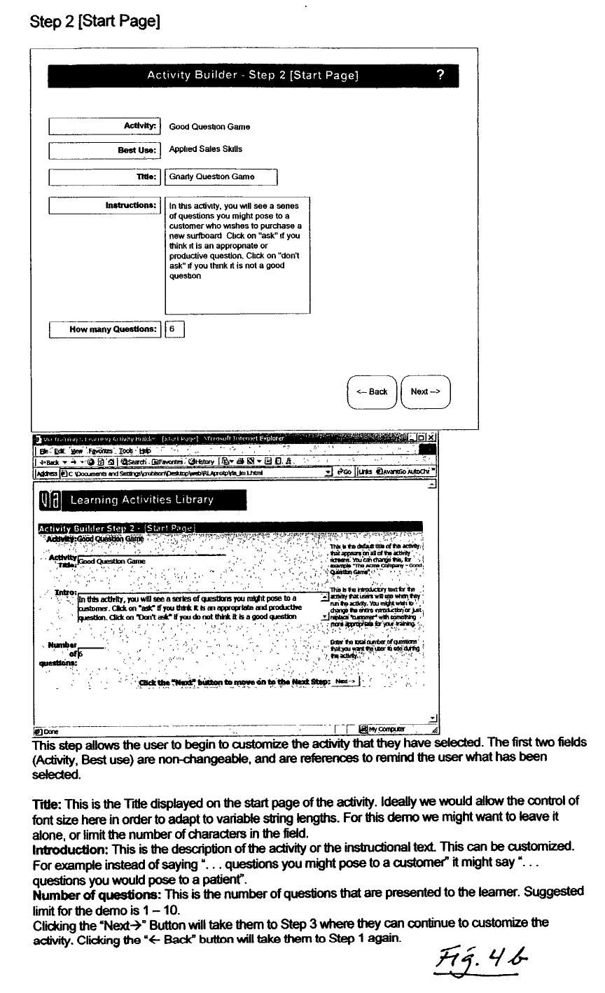

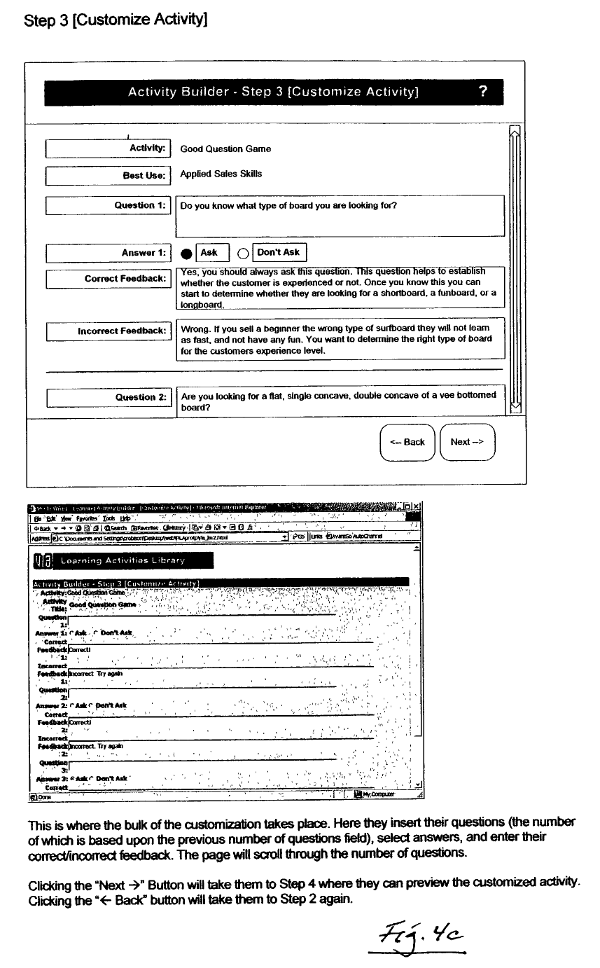

Turning attention now to the drawings, and referring first of all to FIG. 1, indicated generally at 10 is a data-communication environment (represented by the bracket) wherein an e-learning activity 12 is presented for use. This activity, as shown in FIG. 1, is made available to an e-learning trainee, also referred to herein as an e-trainee, 14 who is provided access to activity 12 within environment 10 through an appropriate data-communication interface 16. A communication link between e-trainee 14 and interface 16 is represented by double-headed broad arrow 18 in FIG. 1.

With reference for just a moment to what might make up environment 10 in relation to interface 16, these two components are intended to represent the situation that interface 16 might be a completely hand-held personal computer, a laptop computer, a desktop computer, a LAN-connected computer, a WAN-connected computer, or an appropriately Internet-connected computer. There may of course be other useful interface devices that can sit in the place of interface 16 as illustrated in FIG. 1, and the present invention is fully implementable by any such other kind of interface structure. E-learning activity 12, which is constructed, and which is used, in accordance with the present invention, is made available in the environment shown at 10 in FIG. 1 in a manner which allows trainee 14, at his or her own selection and pace, to engage in the learning content which is offered by activity 12. For the purpose of illustration herein, e-learning activity 12 is one which is designed to provide training in the field of sales, and is specifically an activity which, say, the employer of trainee 14 has decided to make available as a training asset for trainee 14. Other fields of training endeavor may also take advantage of an activity constructed in accordance with this invention, such as activity 12, but the field of sales training has been found to be one wherein the present invention has and offers particular utility.

Still with reference to FIG. 1, activity 12 is also referred to herein importantly as a selectively re-configurable, reusable, revisable, e-learning activity which is made up, in accordance with the invention, with two fundamental components. These two components include what are referred to herein as a core component 20, and a deliverable-content component 22. These two components are operatively linked, and such linking is represented in FIG. 1 by dashed line 24.

Still speaking in somewhat general terms, activity 12 has been prepared for use in environment 10 by packaging it in what is referred to herein as a data-communication-environment wrapper which may take on a number of different well known forms such as SCORM, AICC, LRN, or some other standard-based communication wrapper. This wrapper in FIG. 1 is shown generally at 26.

One will note that component 20, which is shown as a simple block, is shaded with upwardly and to the right angled shading lines. Similarly, deliverable-content component 22 is shaded with more densely packed lines which slope upwardly and to the left. Finally, wrapper 26 (fragmentarily only in FIG. 1) is shaded with intersecting or cross-hatching angled lines. These three shading approaches have been chosen to help distinguish and differentiate the three elements with respect to how they are illustrated in FIGS. 1, 2 and 3 in the drawings.

In the fully constructed state which is shown for activity 12 in FIG. 1, component 20 takes the form herein of a reusable e-learning activity template assembled in electronic data form, and made up of a selected collection of attributes which are distinctly related with a selected e-learning activity. This selection of attributes defines what is referred to herein as the core framework of activity 12, and includes such things as (a) various verbal and visual characteristics of a learning activity, which may include sound material, (b) written text material, such as questions, answers, feedback and instructional strings. It also includes selected visual elements such as color and form, and may include, particularly with respect to text material whether oral or printed, a tone of voice and a style of verbal expression which the creator of activity 12 has determined to use in relation to the presentation of training information to a trainee, such as trainee 14. Collectively, the attributes which have been chosen to provide a core framework for activity 12 can be thought of as defining a training personality for that activity, which personality becomes displayed and presents itself, as will be mentioned again later, during engagement with the activity by a trainee, such as trainee 14.

Distributable-content component 22 herein takes the form of another selection of elements in the forms of specific e-learning, application-specific pieces of information that very specifically determine what it is that is delivered and presented to a trainee in the context of the attributes for activity 12 which are determined by template 20.

An important feature of the present invention, among others, is that, in a certain manner of speaking, the contents of component 22 are independent of the attributes which make up template 20. Such independence exists in the sense that both the attributes within template 20 and the contents within component 22 can be changed independently. It is, in point of fact, this feature of changability which constitutes and important advance and offering made by the present invention. This feature allows, for example, a core template to be created for a particular type of learning activity, linked appropriately to a default set of information constituents within component 22, and provided to a user, such as an employer planning to provide training to employees. Very specifically, the linked combination of components 20, 22 freely allows the acquiring employer to make a wide array of changes from time to time in the specific overall makeup of an activity, like activity 12. In addition to such re-configurability and changability, importantly offering a user the opportunity to change the character of a training activity by changing constituents within component 22, it may also be very useful and desirable and important to provide that same user with an opportunity to make changes in the core template of attributes itself. As shown in FIG. 1, it is assumed herein that e-learning activity 12 has a particular personality defined by a particular collection of attributes in template 20, and presents, in accordance with the training personality defined by those attributes, through the contents of component 22, a specific training presentation, questions, answers, comments, images and sounds, etc., to a trainee, such as trainee 14.

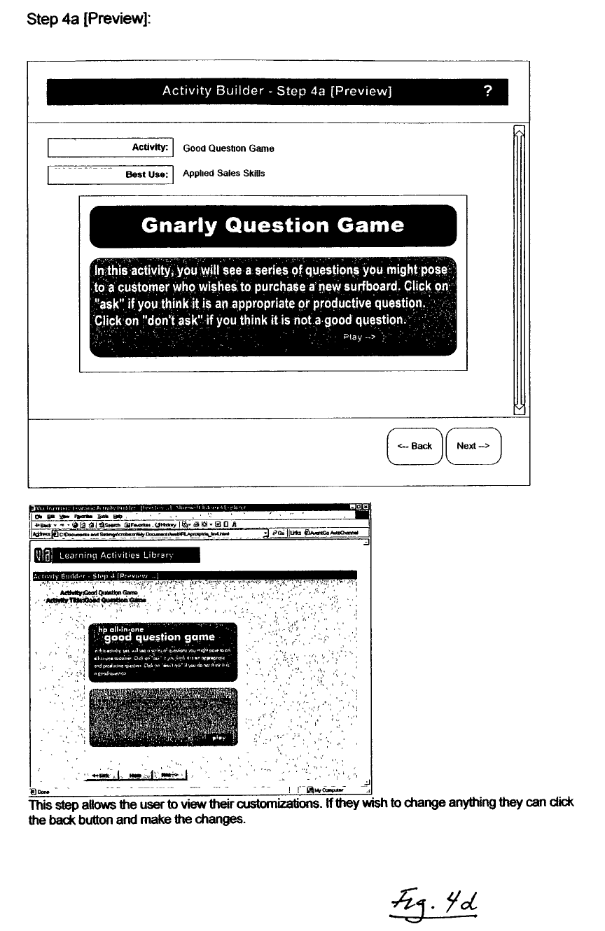

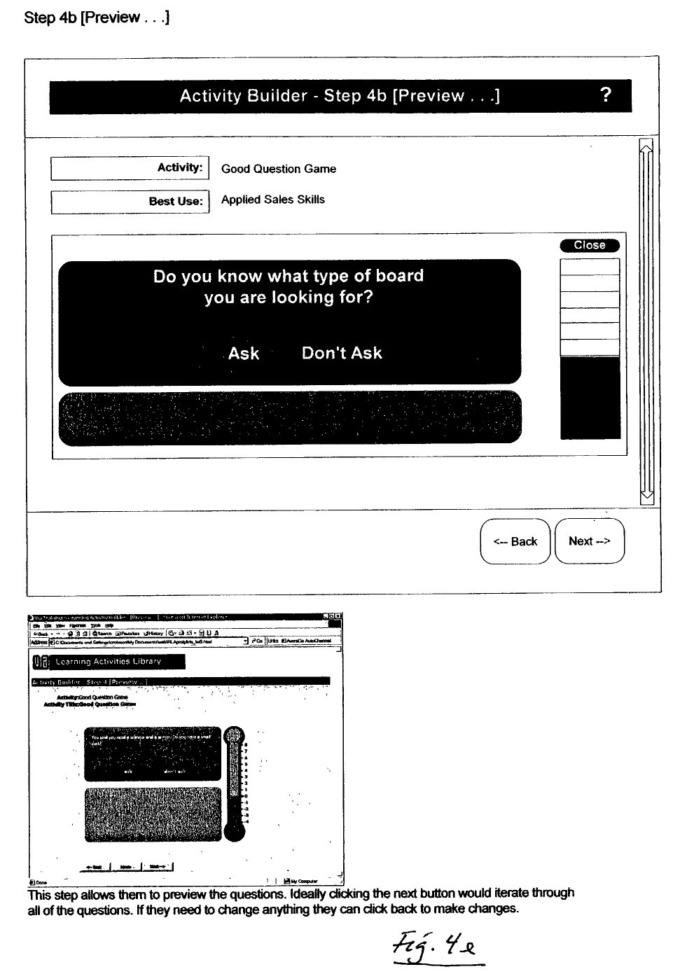

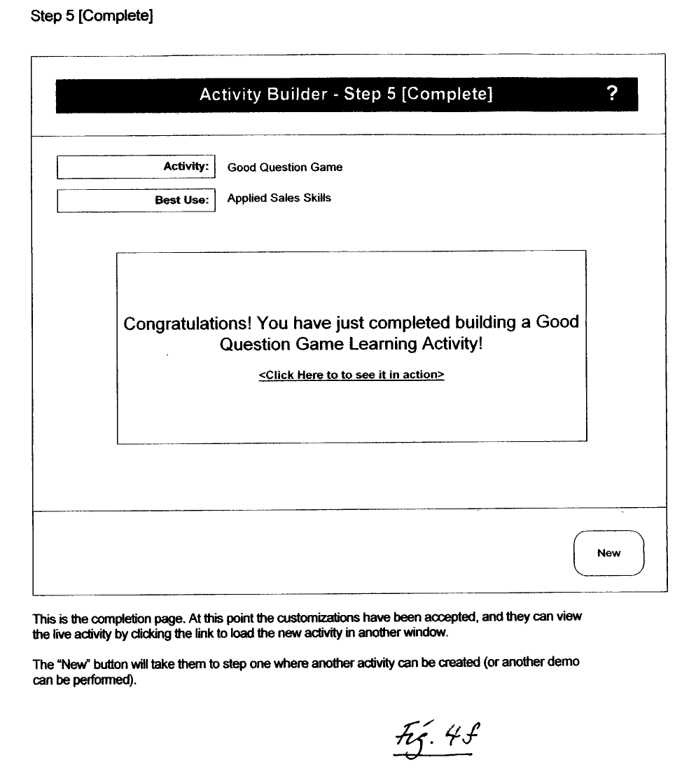

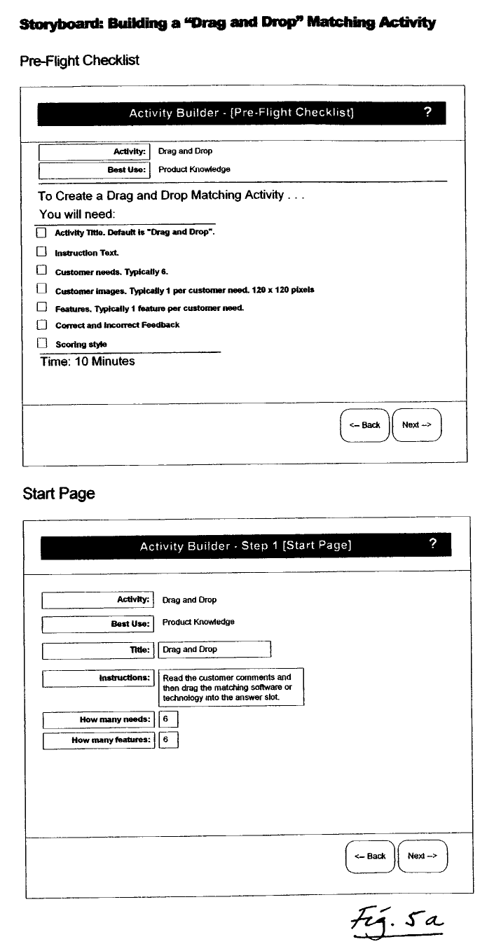

Shifting attention now to FIG. 2, here there is very specifically illustrated, in general terms, that important feature of the present invention which relates to and offers revisability and free re-configurability of activity 12, through changes that may be made easily in the content, for example, of the specific training information component 22. For the sake of continuity and clarity herein, the very same numbers that have been used in FIG. 1 to point out generally the make up of activity 12 are also employed in FIG. 2 recognizing, of course, that with respect to FIG. 2, we are now looking at the impressive re-configurability which is enabled for activity 12 by the present invention.

Reading from left to right across the upper portion of FIG. 2, shown at 20 is an already fully constructed e-learning activity template which, in relation to what else is shown in FIG. 2, and with specific reference to methodology which is provided by the present invention, can be thought of as being acquired as a precursor to the activity pictured in FIG. 2 that involves assembling and/or re-configuring an e-learning activity, such as activity 12. To the right of stand-alone template 20 in FIG. 2 is a block 28, which represents a re-useable c-learning activity builder, and to the right of this builder is a block 30 which can be thought of as constituting an output block, wherein an activity assembled within block 28 is prepared with a wrapper for delivery and use into and in a data-communication environment, such as previously mentioned environment 10.

A block 32 which resides at the lower side of FIG. 2, and which is shown somewhat fragmentarily, represents an available selection, or collection or population, of application-specific information units, or content elements, that can be selected for introduction through block 28 into the assembly of an e-learning activity which is to be based upon attribute template 20.

With regard to the assembly and/or revising or re-configuring activity which is pictured in FIG. 2 with respect to the specific structure of activity 12, one can think of template 20, in the environment of builder 28, as being a tool which offers an effective interface for the assembly of specific features in and for activity 12. Assuming, as has just be mentioned, that template 20 is a fully assembled and acquired template, what is now going to be described with respect to FIG. 2 does not involve any changing taking place within the make-up of template 20.

As has been suggested earlier herein, template 20 is made up, essentially, of various attributes which have been selected from a population of attributes deemed to be especially capable of defining the core character of activity 12. As will be explained shortly, there is indeed a selection process which is associated with the construction of template 20, this process being one which allows the template to be tailored and created to have special qualities. Fundamentally, the attributes within template 20, at a core level, describe the structural aspects of the chosen activity. They also describes any special colors, graphics, or other appropriate style elements that are to be associated with the related e-learning activity, and they contain information relative to whether, and in what amount, for example, questions, answers, feedback, and instructional strings are to play a role in defining the learning personality which the final activity (12) will display.

Within builder 28, therefore, with template 20 readied appropriately, and acquired for assembly into activity 12, the creator of the activity, or the re-configuror of the activity if that is the case, draws into the builder selected specific application information which is to play a role in the ultimate training engagement which will take place with the finished activity. Thus, shown in various sizes and shapes of blocks 34 in population 32 in FIG. 2, are different pieces of specific training information which are selected and sent into builder 28 in order to create operative linkages between these selected pieces of information and the attributes in template 20. Three, different-length, upwardly pointing arrows extend from population 32 to builder 28 in FIG. 2, and each of these arrows represents a different selection of one or more information elements from within population 32 for specific linkage with template 20.

When this linkage activity has been accomplished, there resides in builder 28 a finished form of activity 12, and this is so pictured within the dashed lines that exist within the image of builder 28 in FIG. 2.

The selection and linking process which takes place between blocks 28, 32, as pictured in FIG. 2, describe fundamentally how the possibilities of revision and re-configuration can be implemented in accordance with the invention. For example, it is possible for an activity-builder person to remove an existing information element from block 22, to augment information already within that block, to replace information in block 22 with something drawn from block 32 and also to perform internal variation within a body of information application specific within block 22.

It is thus the case, that, without in any way disturbing or affecting the basic core make-up of attribute template 20, the final shape of activity 12 can readily be configured to take on a very wide range of specific characteristics.

With reference now to FIGS. 4a-4f, inclusive, and 5a-5d, inclusive, in these two collections of drawing figures, the details of learning activity assembly, as pictured in FIG. 2, are presented in considerable detail with respect to two different illustrative e-learning activities aimed into the world of sales. The various images presented in FIGS. 4a-4f, inclusive, describe an activity building procedure involving a sales training activity referred to with the title “Good Question Game Activity”.

FIGS. 5a-5d, inclusive, illustrate, in detail, the construction of another activity which here bears the title “Drag and Drop”.

Those skilled in the art studying drawing FIGS. 1 and 2 along with the two illustrated activity building illustrations found in the FIGS. 4 and 5 groups of images, will readily see how to construct a very wide range of e-learning activities utilizing the technique of linking selected application-specific contents to a pre-assembled activity template constructed from selected activity attributes.

Returning focus specifically to FIG. 2, block 30, wherein an activity, such as activity 12, which has been built within builder 28 is presented for finalization, so-to-speak, it is here that the completed e-learning activity is wrapped with an appropriate data-communication-enabling wrapper, such as previously mentioned wrapper 26. Such wrapping activity is directly pictured on the upper right side of FIG. 2.

With completion of the work performed in block 30, e-learning activity 12 is ready for employment in a data-communication environment, such as environment 10 shown in FIG. 1.

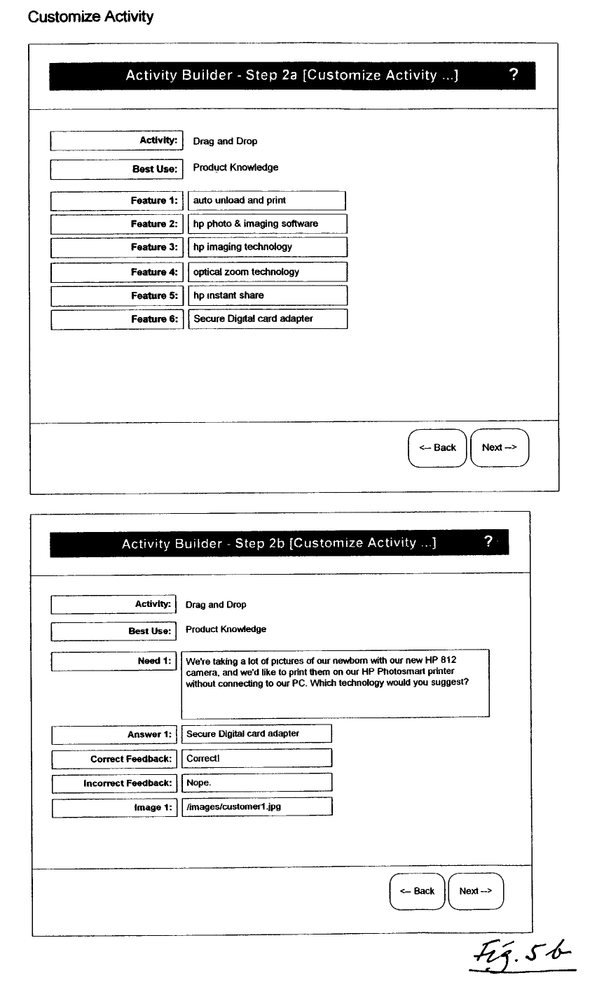

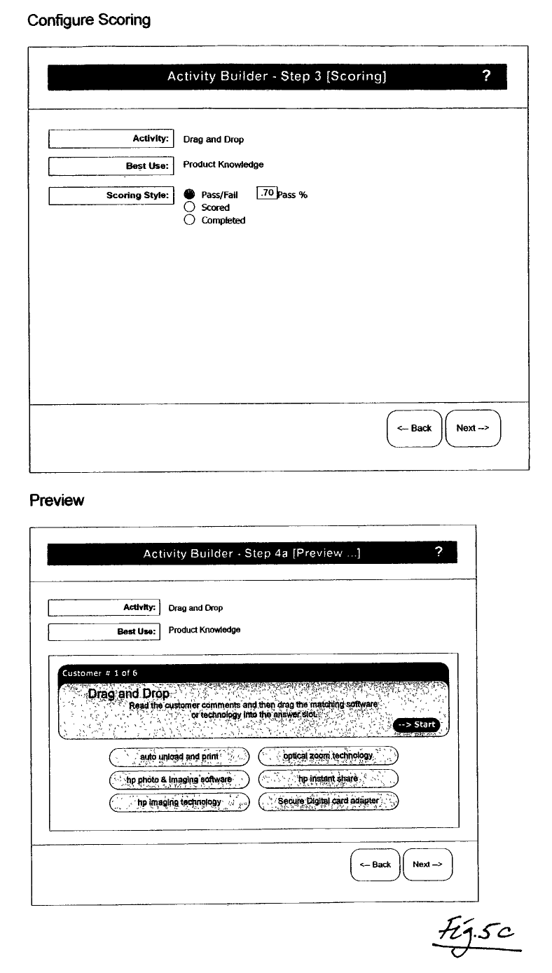

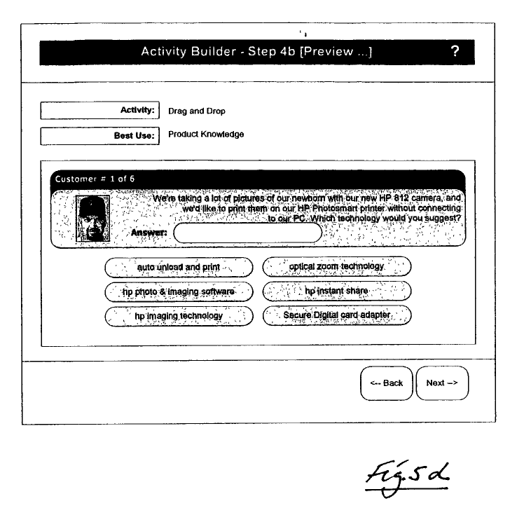

As was mentioned earlier herein, another area wherein the present invention provides substantial versatility with respect to the creation of an e-learning activity relates to the opportunity provided by the invention for changing the attribute make-up of template 20. In FIG. 3, a fragmentary block 36 contains a large population of various activity attributes which are shown in this block by the small and differently sized and shaded rectangles shown at 38.

As is illustrated by the three different-length arrows that point to the right in FIG. 3 from block 36, a person engaged in the act, in accordance with the invention, of assembling a template of attributes makes any selection of attributes to employ, and feeds them to a template builder represented by block 40 on the right side in FIG. 3. Emerging from work that is preformed within builder 40 in FIG. 3, is an activity template of attributes, such as template 20 which is pictured on the inside of block 40 in FIG. 3.

The process thus illustrated and generally described with respect to FIG. 3, has many of the same characteristics as does the process that is illustrated regarding the cooperation between blocks 28, 32 in FIG. 2. More specifically, a person operating in accordance with FIG. 3 is enabled to construct initially, or to modify and reconfigure later, a freely selected activity template 20 having all of the elements that lead to an e-learning personality as was described above.

It will thus be apparent how the contributions made by the present invention offer a very unique and versatile opportunity for the creation, re-configureably and reuseably, of a host of e-learning activities, such as those mentioned herein that relate to the field of sales. The level of independence described earlier which exists between an activity template and the application-specific information which becomes linked to attributes within that template, provides a very efficient environment within which to create a very wide range of differing e-learning activities, without having to go through the process of necessarily changing template construction and componentry every time that there is a desire to change information content characteristics in an activity.

Thus, while a preferred embodiment and manner of practicing the present invention have been described and illustrated herein, it is appreciated that many variations and modifications may be made without departing from the spirit of the invention.

I claim:

1. A selectively re-configurable e-learning activity employable in an electronic data-communication environment comprising
a selectively reusable e-learning-activity template existing in electronic form, and containing, for a particular category of e-learning activity, a selected collection of attributes which define a core framework for that activity, and
a selection of e-learning application-specific information which is nominally independent of said template, appropriately associated with said attributes, and revisably and re-configurably linked operatively to said template in a manner whereby said template and said linked information cooperate and collaborate to form said activity.

2. The activity of claim 1, wherein the mentioned revisable and re-configurable linked status which exists between said template and said information is structured to permit specific re-configuring of the resulting e-learning activity through changes made in the content of the linked information, which changes result from the performance of at least one of the modifying acts drawn from the list including (a) removing, (b) augmenting, (c) replacing, and (d) internally varying, component contents of the linked information.

3. The activity of claim 1, wherein said selected attributes cover subject matters associated both with verbal and with visual characteristics of the particular category of e-learning activity.

4. The activity of claim 3, wherein such verbal characteristics include one or more of (a) written, and (b) aural text material.

5. The activity of claim 4, wherein such verbal characteristics include one or more of (a) questions, (b) answers, (c) feedback, and (d) instructional strings.

6. The activity of claim 3, wherein said selected attributes additionally involve sound material.

7. The activity of claim 3, where revisions made regarding the relationships between said linked information and said attributes to re-configure the specific construction of the e-learning activity are performable structurally without making any changes in the template of attributes.

8. The activity of claim 1, wherein the data-communication environment can take any one or more of the forms including (a) a hand-held computer in any form, (b) a stand-alone computer, such as a laptop or desktop computer, (c) a local-area-network-connected computer, (d) a wide-area-network-connected computer, and (e) an Internet-connected computer.

9. The activity of claim 1, wherein said template of attributes is structured to allow the making of selective changes to it per se by permitting alterations to be made with reference to at least one attribute therein.

10. The activity of claim 1 which further includes a data-communication-environment wrapper operatively associated with said activity for the purpose of making it usefully available in the data-communication environment.

11. A method for creating a selectively re-configurable e-learning activity employable in an electronic data-communication environment comprising
acquiring a selectively reusable e-learning-activity template existing in electronic form, and containing, for a particular category of e-learning activity, a selected collection of attributes which define a core framework for that activity,
making that template available for use in a process employed to construct the activity,
choosing, from an available population of possibilities, a selection of e-learning application-specific information appropriately associated with such selected collection of attributes, and
revisably and re-configurably linking that chosen selection of information operatively to said template in a manner whereby the template and the linked information cooperate and collaborate to form the desired e-learning activity.

12. The method of claim 11, wherein said revisable and re-configurable linking between the template and application-specific information is performed in such a manner as to permit free specific re-configuring of the resulting e-learning activity through making changes in the content of information selected from the available mentioned population of information, which changes specifically result from the carrying out of at least one of the modifying acts drawn from the list of acts including (a) removing, (b) augmenting, (c) replacing and (d) internally varying component contents of the selected linked information.

13. The method of claim 12, wherein re-configuring of the resulting e-learning activity is performed in a manner which produces no substantive changes in the acquired template of attributes.

14. The method of claim 12, wherein said acquiring of an activity template is performed through carrying out a prior act of assembling the template from an available population of e-learning, activity-specific, selected attributes.

15. The method of claim 11 which further includes the step of wrapping the created activity in an appropriate delivery wrapper in order to make the activity usefully deliverable to an e-trainee in the mention data-communication environment.

16. A selectively modifiable e-learning activity employable in an electronic data-communication environment, and characterized generally by independent and differentiated core and deliverable-content components, said activity comprising
a core component in the form of an electronic attribute template possessing, and endowed by, selected learning-activity attribute constituents which collectively reflect a selected e-training personality, and
a variable selection of deliverable content components in the form of e-learning application-specific information linked operatively to said attributes, and deliverable to an e-learning trainee in a manner which displays said training personality.

17. The activity of claim 16, wherein the selected e-training personality is contributed, at least in part, by an attribute which relates to at least one of the characteristic elements contained in the list including (a) color, (b) visual form, (c) apparent tone of voice, and (d) style of verbal expression.

19. The activity of claim 16, wherein modification of an existing e-learning activity is performed, at least in part, by modifying the content-component makeup of the application-specific contents that are linked to said attributes.

19. The activity of claim 18, wherein modifying of an e-learning activity is further accomplished, at least in part, by modifying the attribute content of said template.
